(19) United States
(12) Patent Application Publication
(10) Pub. No.: US 2006/0142889 A1
(43) Pub. Date: Jun. 29, 2006

(54) Verification system

(76) Inventors: Robert Duggan, Piltown (IE); Mike Fleming, Ballinakill (IE); Brian Cooney, Lauradell (IE); John Stapleton, Tramore (IE); Richard Connelly, Carrick-on-Suir (IE)

Correspondence Address: Bausch & Lomb Incorporated, One Bausch & Lomb Place, Rochester, NY, 14604-2701, US

(21) Appl. No.: 11/025,419

(22) Filed: Dec. 29, 2004

(51) Int. Cl. G06F 19/00

(52) U.S. Cl. 700/109; 700/117

(57) ABSTRACT

A verification system for a batch manufacturing process comprises comparing manufacturing order information obtained from an electronic database to the label or other representative data obtained from the beginning and end of the production batch. In a preferred embodiment, an empty carton is produced at the beginning and end of each lot or batch which is read by an OCR and compared to the manufacturing order information retrieved from an electronic database.

### BACKGROUND OF THE INVENTION

This invention relates to production processes and in particular to a method of verifying that a batch or lot of articles has been processed in accordance with the production parameters.

In many production processes it is necessary to keep a history record for each lot of product produced on a production line. In certain industries, particularly the pharmaceutical and medical device industries, it is a requirement of the regulatory authorities that a detailed history record is kept for each lot of product. The history record generally comprises details of the order for a particular lot of products, lot number associated with the lot, number of articles in the lot, date of manufacture, and sufficient details of the articles to enable an individual article to be associated with the lot. In some cases the history record includes physical evidence such as labels from the first and last article produced in a lot and/or the first and last carton in which the lot of articles are packaged.

In the case of disposable contact lenses, the production process involves placing each lens in an individual blister pack which is sealed and labelled. It has been the practise to remove the labels from the first and last blister package in a lot and attach these labels to the device history record. Further down the production line or in a separate production line, a plurality of the lens blister packs are inserted in cartons to be distributed to the end user. It is known to take the first and last carton from a lot, empty the product and attach the empty cartons to the device history record to provide physical evidence for the lot record.

An alternative to the removal of a label from a product at the start and end of every lot is to generate an additional label at the start and end of each lot and to use these additional labels as evidence on the history record.

Our co-pending British Patent Application No. 0322265.0 discloses a method of making a history record of a lot comprising a plurality of articles processed in a production line which comprises:

(a) imaging a sufficient portion of the first article in the lot or identification means associated therewith to identify said first article,

(b) imaging a sufficient portion of the last article in the lot or identification means associated therewith to identify said last article, and

(c) storing the images to provide a record of the lot.

That invention provides a simple and effective means of making a history record of a lot. A sufficient portion of the first article in a lot or identification means associated therewith e.g. a label is imaged, preferably by a digital camera, to provide a record sufficient to identify the first article. Similarly, a corresponding image is taken of the last article in a lot. By using digital imaging it is readily possible to print the images of the first and last article in a lot directly on the history record. The production process can be computer controlled such that the two images are taken automatically at the beginning and end of a lot and the image is printed on the history record.

When a batch of articles has been completed it is necessary for the batch to be checked before it is released from the manufacturing stage. The device history record is checked against the details of the manufacturing order. For example, the samples or images of the labels, and/or samples or images of the cartons are checked to ensure the labelling and packaging is in accordance with the manufacturing order. If there is a discrepancy between the labels/packaging and the manufacturing order the batch will not be cleared and will be subject to re-examination and possibly rejected. The checking procedure is generally conducted manually by visual inspection. It has been found that human checking of large quantities of batches and their associated data is not always effective.

The invention has been made with this point in mind.

### SUMMARY OF THE INVENTION

According to the present invention there is provided a method of verifying that a batch of product conforms with a manufacturing order which comprises:

(i) providing an electronic database with information of the manufacturing order for said batch;

(ii) providing a device history record of said batch which comprises samples and/or images of labels and/or packaging associated with product at the beginning and end of said batch;

(iii) inspecting said samples and/or images using a camera associated with optical character verification software;

(iv) comparing the data generated by the camera and the optical character verification software with information of the manufacturing order from said electronic data base; and

(v) providing an indication as to whether said batch passes or fails based on the comparison of step (iv).

The invention provides a verification system for use in a batch manufacturing process which allows a batch to be automatically checked before release from the manufacturing stage without fatigue on the part of the operator. It has been found that imaging or scanning information relating to products at the start and end of a batch e.g. labels, cartons etc and using the resulting information in a verification process to compare the generated data with information from an electronic database relating to the manufacturing order of the batch provides an efficient, automated verification system which is more efficient than can be achieved by manual inspection by operators.

The precise procedure will depend upon the product being manufactured in the batch and whether a plurality of product items are packaged in cartons or the like. It is important when verifying a lot or batch to examine information relating to the product at the start of a batch and at the end of a batch in order to verify that the lot or batch has not become contaminated and that all of the products belong to the particular lot or batch. There is an inherent danger in batch manufacturing processes where there may be a plurality of lots proceeding down a production line that the detection of the end of one lot and the beginning of the next lot may fail which could cause the product from one lot being confused with the product from an adjacent lot.

The verification system of the invention is suitable for use in a batch production process which comprises an electronic database with information relating to the manufacturing order. It is known to use a computer-aided management system or the like which comprises an electronic database providing detailed information about the manufacturing requirements of a lot. The information will include a lot number, the number of products to be made, the specification of the products, e.g., in the case of contact lenses the information may include prescription data, details of the manufacturing process as the product proceeds from stage to stage, information relating to the data to be printed on labels and information relating to the data to be printed onto packaging, etc. The database is normally repeatedly interrogated by the various manufacturing stages to ensure that the production line is properly controlled at each stage.

The verification system of the invention may follow a procedure as follows:

(a) the operator receives the manufacturing order relating to a manufacturing lot;

(b) the lot identification on the manufacturing order is read e.g. by a barcode scanner;

(c) information relating to the lot is obtained from the electronic database of the manufacturing order e.g. information relating to the contents of the label of the product;

(d) the label (or image thereof) of the first product in the batch is placed under a camera for imaging and electronic verification of the content of the label by comparison with the data obtained from the electronic database;

(e) the label (or image thereof) from the last product in the batch is placed under a camera for imaging and electronic verification of the content of the label by comparison with the data obtained from the electronic database; and

(f) the system will provide an indication as to whether the batch has passed or failed the verification process.

In the event of a failure the product may be manually inspected since the failure may be due to imperfect printing, creased label etc. and the batch may not be contaminated.

The system has the potential to image and scan any desired information relating to product and packaging. Thus, the information scanned and verified is not limited to alpha-numeric information, barcodes and matrices but can also verify artwork and other image data.

In a preferred embodiment, the product packaging line is set up to produce an empty carton (having the product information printed directly thereon or on an applied label) at the beginning and end of each lot or batch. The empty cartons may be used as the device history record so that cartons holding actual product need not be pulled from the lot for the verification purpose. Alternately, extra labels not affixed to a carton may be produced on the packaging line for this purpose.

### DESCRIPTION OF THE DRAWING

FIG. 1 is a flow diagram of a preferred embodiment of the verification system in accordance with the invention.

### DETAILED DESCRIPTION OF THE INVENTION

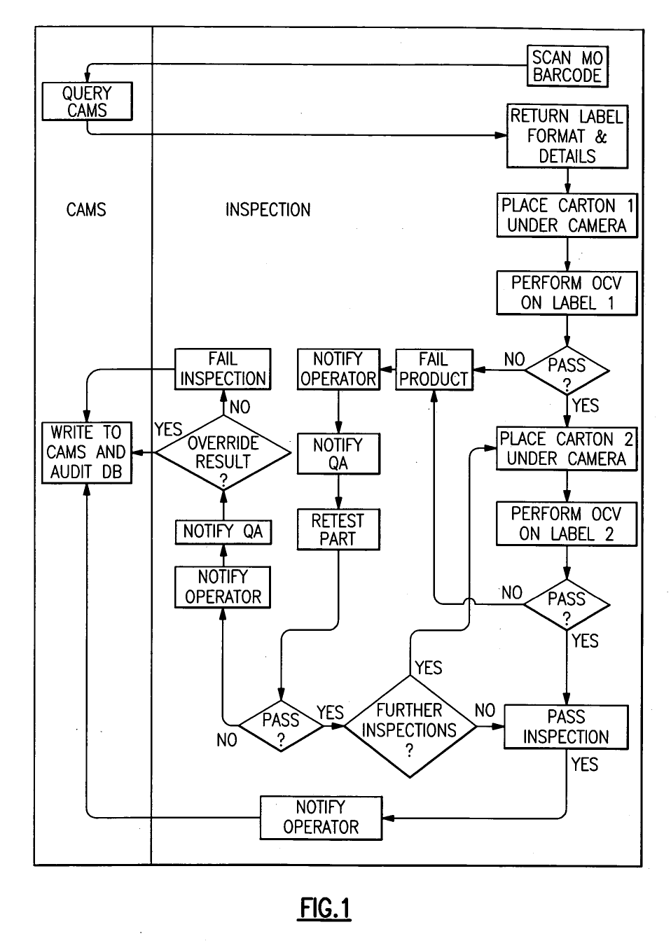

The flow diagram of FIG. 1 is divided into two sections, the left-hand section being CAMS which is an electronic database with information of the manufacturing order for a batch, and INSPECTION, which is the verification system.

The operator will operate at a workstation (not shown) which generally comprises a personal computer having the software associated with the verification system, the computer being linked to a camera and barcode scanner and having the ability to download information from CAMS and transfer status data to CAMS.

The operator receives the manufacturing order and scans the barcode to identify the lot number. CAMS is automatically interrogated and returns the information required for the verification procedure, e.g., label format and details. The user places the first carton or label (or image thereof) under the camera and activates the optical character verification system. The label is scanned and the retrieved data compared with the details received from CAMS. If the comparison is satisfactory there will be a visual and/or audio indication that the information relating to the first product has passed.

Assuming the first stage is passed, the operator will place the carton or label (or image thereof) associated with the last product of the batch under the camera and the procedure repeated. If the product passes the verification, the batch may be released from the manufacturing stage. This information is passed to CAMS to update the manufacturing record.

Should the first product fail, the operator may repeat the test and/or make a visual inspection to determine whether the product may be verified as a pass. In the event that the product passes on retesting then the operator proceeds with the test of the last product in the batch. In the event the product fails the verification test, this information is transferred to CAMS and the batch is not allowed to be released without subsequent investigation, including, e.g., quality assurance (QA).

Similarly, if the information relating to the last product in the batch fails the initial verification test, it may be retested as described above.

The verification system of the invention is particularly suitable for batch manufacturing processes of contact lenses. Contact lenses, particularly for correction of astigmatism, are manufactured to many different prescriptions and a production or packaging line may have multiple lots on the line at any time.

1. A method of verifying that a batch of product conforms with a manufacturing order, wherein said product comprises contact lenses, said method comprising:
(i) providing an electronic database with information of the manufacturing order for said batch,
(ii) providing a device history record of said batch which comprises samples and/or images of labels and/or packaging associated with product at the beginning and end of said batch,
(iii) inspecting said samples and/or images using a camera associated with optical character verification software,
(iv) comparing data generated by the camera and the optical character verification software with information of the manufacturing order from said electronic data base, and
(v) providing an indication as to whether said batch passes or fails based on the comparison of step (iv).

2. The method of claim 1 in which labels associated with said product at the beginning and the end of said batch are inspected in step (iii).

3. The method of claim 1 in which images of said device history record associated with said product at the beginning and the end of said batch are inspected in step (iii).

4. (canceled)

5. The method of claim 1 in which the manufacturing order is represented by a barcode identifying a batch and the barcode is read and used to obtain information of the manufacturing order for the batch from the electronic database.

6. The method of claim 1 wherein said device history record comprises an empty carton produced at the beginning and end of said batch.
